(19) United States
(12) Patent Application Publication
(10) Pub. No.: US 2005/0138131 A1
(43) Pub. Date: Jun. 23, 2005

(54) Method and system for creating pervasive computing environments

(76) Inventors: Donald E. Armstrong, Westlake Village, CA (US); Ashish Khosla, Tallahassee, FL (US)

Correspondence Address: CHRISTIE, PARKER & HALE, LLP, PO BOX 7068, PASADENA, CA, 91109-7068, US

(21) Appl. No.: 11/039,223

(22) Filed: Jan. 20, 2005

Related U.S. Application Data
(62) Division of application No. 09/858,995, filed on May 15, 2001.
(60) Provisional application No. 60/205,934, filed on May 15, 2000.
(60) Provisional application No. 60/205,586, filed on May 16, 2000.
(60) Provisional application No. 60/213,355, filed on Jun. 22, 2000.

(51) Int. Cl. G06F 15/16

(52) U.S. Cl. 709/206; 709/246

(57) ABSTRACT

A concise linked document language, a computer network client interpreting the concise linked document language, and exemplary applications using the concise linked document language. The concise linked document language incorporates features which allow presentation, acquisition, and document links using a distributed client composed of a computer network device linked via a communications link to an information device. The distributed client can be used to access servers located on a computer network from almost any information device creating a pervasive computer networking environment. The features of the concise linked document language allow rapid construction and deployment of Internet based applications which are extended by existing communications links such as a voice/email system where the native email documents may be presented as either text or voice depending on the presentation capabilities of the information device.

### CROSS-REFERENCE TO RELATED APPLICATION(S)

This application is a division of U.S. application Ser. No. 09/858,995, filed May 15, 2001, which claims the benefit of U.S. Provisional Application No. 60/205,934 filed on May 15, 2000, U.S. Provisional Application No. 60/205,586 filed on May 16, 2000, and U.S. Provisional Application No. 60/213,355 filed on Jun. 22, 2000, which are hereby incorporated by reference as if set forth in full herein.

### BACKGROUND OF THE INVENTION

This invention relates generally to the field of computer network based user applications and specifically to accessing computer network based user applications over diverse communications links.

The combination of the Internet, client/server architectures, and Hypertext markup languages allowed the creation of an easily navigated global data network known as the World Wide Web (Web). The Web is composed of Web servers and Web clients interconnected by a network of computers communicating to each other using the Transport Control Protocol/Internet Protocol (TCP/IP) suite of communications protocols. The resultant network is commonly called the Internet. Web servers deliver documents known as Web pages to Web clients when requested by the Web clients. The documents are commonly written in a document markup language called Hyper Text Markup Language (HTML). The Web clients that request and receive the documents are known as browsers and are typically hosted by personal computers. Browsers receive the documents and interpret the documents to create an interactive display on a computer terminal.

Markup languages such as HTML were designed to allow creation of documents whose format could be reconstructed whenever the document was presented on a display device. Therefore, HTML specifies the syntactic structure of the document but does not specify a semantic meaning for the syntactic structure. This means that browsers are free to supply semantic meaning for a document. Browser designers have exploited this feature of HTML by adding interactive components to browsers that enhance the use of HTML documents. As HTML has evolved, more and more fields or tags have been added to the language to expand the available interactive features offered by browsers. Many of these interactive features exploit a browser's ability to access the Input and Output (I/O) devices on personal computers such as graphic display screens, pointing devices, and keyboards. As time has passed, HTML development has been driven by the possibilities of browser design to the point where documents written in HTML are dependent on fully exploiting the I/O devices which are commonly found on personal computers. The desire to add ever greater functionality to HTML documents has even lead to the development of Dynamic Hyper Text Markup Language (DHTML) and general purpose scripting languages, such as Java and VBscript, which can be embedded in HTML documents. DHTML and scripting languages allow for significant client side processing which may not have been contemplated when the first version of HTML was invented.

The rapid development of HTML into a document markup language which is heavily dependent on the I/O and computing resources of a personal computer has created a limitation on pervasive access of the information available on the Web. The Web is now almost completely dominated by Web servers with documents which can only be effectively displayed on a fully functional personal computer. This heavy dependence on personal computers means that most Web documents cannot be accessed by information devices which are more portable than personal computers but lack the full functional capabilities of a personal computer. For example, a wireless telephone has the capability to present audio information to a user via the earpiece and acquire information from a user via the keypad and mouthpiece. However, the wireless telephone has either limited or no capability to present graphical or textual information to a user. Even as information devices become more capable by expanding in-device computing capabilities and new presentation and acquisition features, Web documents become more complex requiring presentation capabilities which surpass the new capabilities of the information devices. Furthermore, the increased client side computational requirements of Web documents continues to out-pace the new computational capabilities of information devices.

Therefore, a need exists for a method and system to extend Web services to information devices which may not have the full functional capability of personal computers. The present invention meets such need.

### SUMMARY OF THE INVENTION

A user retrieves and interacts with electronic documents located on a computer network using an information device connected via a communications link to a computing device operably coupled to the computer network. Communication signals generated by voice and keystroke acquisition devices located in the information device are transmitted via the communications link to interpreter software located on the computing device. The interpreter software interprets the communication signals and determines if they correspond to a document location on the computer network. If so, the interpreter software retrieves a document from the document location on the computer network. The retrieved document contains a presentation component for presentation to the user and a dialog instructions for guiding a user through linked documents located on the computer network. The dialog instructions also specifies how the interpreter should respond to further user inputs. The interpreter interprets the document sending any presentation components found in the document via the communications link to presentation devices located in the information device. The interpreter accepts further user input and acts upon the input based on the dialog instructions in the document.

The retrieved document is preferably written in a Concise Linked Document Language (CLDL). A concise linked document language has at least three features. A concise linked document language allows for document presentation in such a way as to allow many information devices to be used to present a single document type. A concise linked document language allows for user interaction acquisition through a simple mechanism which enables many types of information devices to be used to acquire user interaction using a single document type. Finally, a concise linked document language allows for navigation between linked documents located on a computer network in a rigorously specified way. A concise linked document language may also allows transfer of the communication link out of the system and recording without interpretation of user interactions.

The combination of presentation and acquisition software located in an information device coupled with the interpreter software located in a computing device connected to a computer network creates a single distributed Internet browser capable of browsing documents written in a concise linked document language. This distributed browser creates a pervasive computing environment that may be accessed from many locations other than traditional Internet enabled locations.

The distributed browser may be used as an element in a voice/e-mail system where documents written in a concise linked document language may be created and retrieved using a variety of information devices without intermediate document translation steps or transferring documents through special gateways. To realize the combination voice/e-mail system, documents are dynamically created using Common Gateway Interface (CGI) scripts that communicate over a computer network using a network protocol selected from the set of Post Office Protocol (POP) protocols.

An IVR system with access to the entire suite of data services available through the Internet can be created by exploiting the browsing features of the single user distributed browser. The Internet IVR system may access documents written in a concise linked document language stored on, or dynamically generated by, any HTTP enabled server on the Internet. The Internet IVR system may also acquire data from any Internet accessible data source which does not communicate via documents written in a concise linked document language by using standard CGI or other Web server document creation services to acquire data from these Internet accessible data sources. Additionally, the Internet IVR system may acquire data from Web pages written in HTML by passing the documents through a HTML to concise linked document language translation program.

A multiuser Interactive Voice Recognition (IVR) Internet gateway usable by multiple users may be created using a multichannel carrier link and a session manager in conjunction with individual sessions of the distributed browser. The multiuser IVR Internet gateway can connect multiple users to different Internet destination based on the Directed Inward Dial (DID) numbers used by each user to connect to the IVR Internet gateway.

The multitasking IVR Internet gateway can be used to support a plurality of content providers distributed across the Internet. The primary advantage of such a system over traditional leased IVR systems is that each individual content provider can customize their own user dialogs and implement their own business rules independently of the IVR interface provider.

### BRIEF DESCRIPTION OF THE DRAWINGS

These and other features, aspects, and advantages of the present invention will become better understood with regard to the following description and accompanying drawings where:

FIG. 1 is a use case diagram of a client/server architecture implemented across a computer network;

FIG. 2 is a deployment diagram of a client/server system deployment distributed over a computer network;

FIG. 3 is a deployment diagram of software objects on a client host;

FIG. 4 is a sequence diagram of the communication sequences between software objects in a client/server interaction;

FIG. 5 is a schematic of a conventional phone showing the organization of acquisition and presentation devices;

FIG. 6 is a schematic of a theoretical information device;

FIG. 7 is a schematic of a client distributed across an information device and computation device;

FIG. 8 is a deployment diagram of a distributed client;

FIG. 9 is a deployment diagram of a distributed client used within a client/server architecture;

FIG. 10 is a sequence diagram of the communications sequence between software objects deployed as shown in FIG. 9;

FIG. 11 is an example of a concise linked document language;

FIG. 12 is a tree diagram of the documents linked by the example of FIG. 11;

FIG. 13 is a deployment diagram showing how an Interactive Voice Recognition (IVR) system can be created using the present invention;

FIG. 14 is a deployment diagram of an Internet based IVR system according to the present invention;

FIG. 15 is a deployment diagram of an Internet based voice and electronic mail (email) system according to the present invention;

FIG. 16 is a sequence diagram illustrating the interactions between the software objects of FIG. 14;

FIG. 17 is a second sequence diagram illustrating the interactions between the software objects of FIG. 14;

FIG. 18 is a deployment diagram illustrating how the Internet services may be used according to the present invention;

FIG. 19 is a sequence diagram illustrating the communication sequence between the software objects of FIG. 17;

FIG. 20 is a second sequence diagram illustrating the communication sequence between the software objects of FIG. 17;

FIG. 21 is a deployment diagram of a communications gateway according to the present invention;

FIG. 22 is a sequence diagram of the operational sequence of the communications gateway ;

FIG. 23 is deployment diagram showing how the communications gateway can be used to support a plurality of content providers;

FIG. 24 is a software architecture diagram depicting an embodiment of the present invention suitable for use with a plurality of linked document languages; and

APPENDIX A is the language specification for a concise linked document language(CLDL).

### DETAILED DESCRIPTION OF THE INVENTION

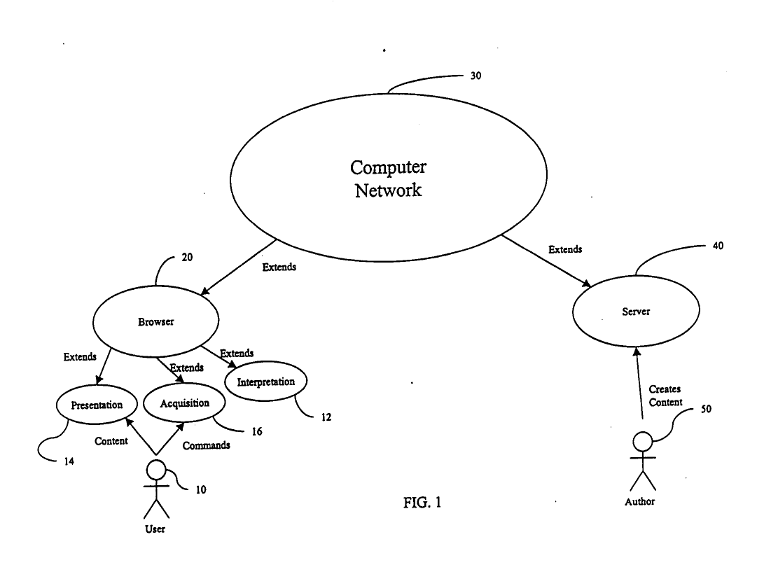

FIG. 1 is a use case diagram of an author distributing content over a computer network using a client/server paradigm. User 10 accesses documents created by author 50 through computer network 30. User 10 accesses documents by using browser 20 to communicate with server 40 through computer network 30. Author 50 creates documents which are stored on server 40 accessible by client 20 through computer network 30. Client 20 extends the functionality of computer network 30 by supplying document presentation 14, user interaction acquisition 16, and document interpretation functions 12. Server 40 extends the functionality of computer network 30 by supplying document transmission and storage capabilities.

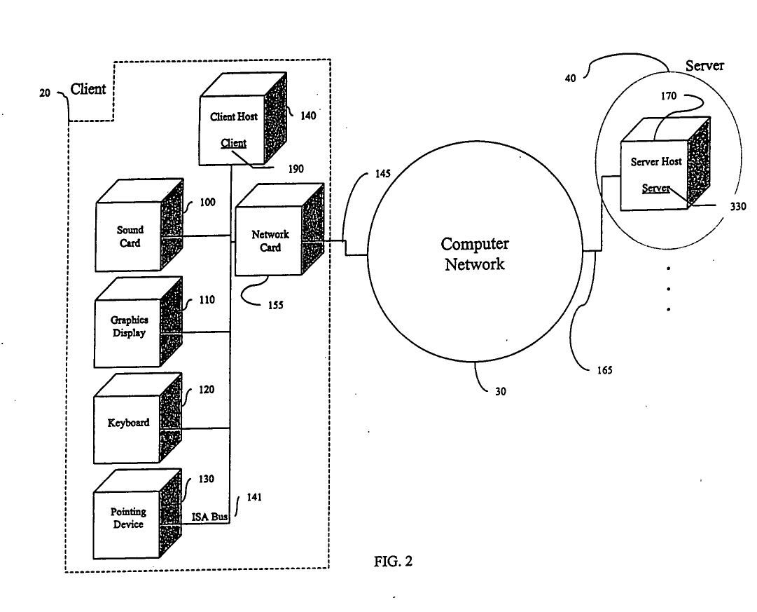

FIG. 2 is a deployment diagram of an exemplary system to provide the document server and browser features of FIG. 1 over a computer network such as the Internet. Client host 140 has access to network card 155, sound card 100, graphics display 110, keyboard 120, and pointing device 130 via internal data bus 141. Network card 155 can handle low level computer network communication services. Sound card 100 can be used to present audio data to a user and also acquire and digitize audio data from the user. Graphics display 110 can be used to display images and text to a user. Keyboard 120 can be used to acquire keystrokes from a user. Pointing device 130 can be used to acquire screen selections from a user. Client host 140 hosts client software object 190. The combination of client host 140, client software 190, sound card 100, graphics display 110, keyboard 120, and pointing device 130 satisfy the functional requirements of browser 20. The client host is preferably a personal computer. Alternatively, the client host can be any general computing device with the afore described features and connected devices.

Server host 170 hosts server software object 330. Server host 170 and server software object 330 perform the necessary functions of server 40. Client software object 190 communicates via communications link 145 to computer network 30. Server software object 330 communicates via communications link 165 to computer network 30. Client software object 190 and server software object 330 communicate to each other using computer network 30.

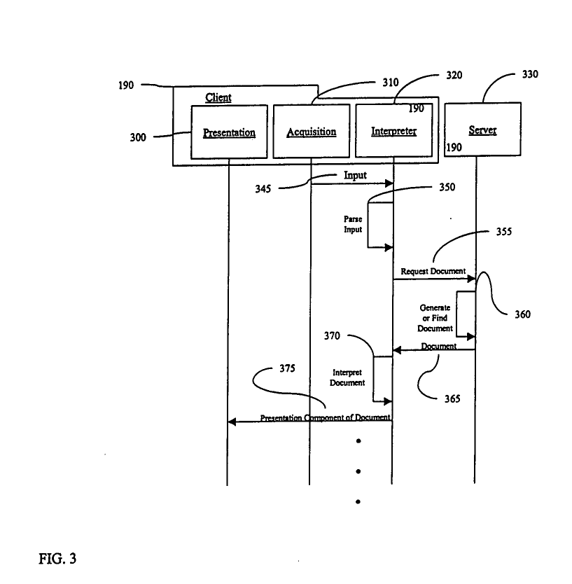

FIG. 3 is a sequence diagram of the communication sequences between software objects depicted in FIG. 2 wherein the client requests documents from the server and the server responds to the client's request by sending documents. Client 190 comprises three functions. Those skilled in the art of software engineering will recognize that software functions can be performed by software components written in either a procedural language such as C or in an object oriented language such as C++. For the remainder of the description of the invention, functional descriptions of software components will be described using object oriented programming terms. Presentation software object 300 presents information to a user using the presentation devices available on the device hosting client 190. Referring to FIG. 2, typical presentation devices are sound card 100 for presentation of audio information and graphics display 110 for presentation of text and graphics. Referring again to FIG. 3, acquisition object 310 acquires user inputs from the acquisition devices available to the device hosting client 190. Referring to FIG. 2, keyboard 120 and pointing device 130 are examples of typical acquisition devices. Referring again to FIG. 3, interpreter software object 320 accepts input from acquisition object 310 and sends output to presentation object 300. Interpreter object 320 also communicates with server software object 330 through computer network 30 of FIG. 2.

Referring again to FIG. 3, a typical client/server interaction is as follows. Acquisition object 310 acquires input from a user through a previously described acquisition device and sends input 345 to interpreter object 320. Interpreter object 320 parses 350 input 345 and determines if input 345 corresponds to a document request. If input 345 does correspond to a document request, interpreter object 320 sends document request 355 to server object 330. Server object 330 either generates or finds 360 the requested document and sends document 365 to interpreter object 320. Interpreter object 320 interprets 370 document 365 and sends presentation component 375 contained in document 365 to presentation object 300. Presentation object 300 uses the previously described presentation devices to present presentation component 375 to a user.

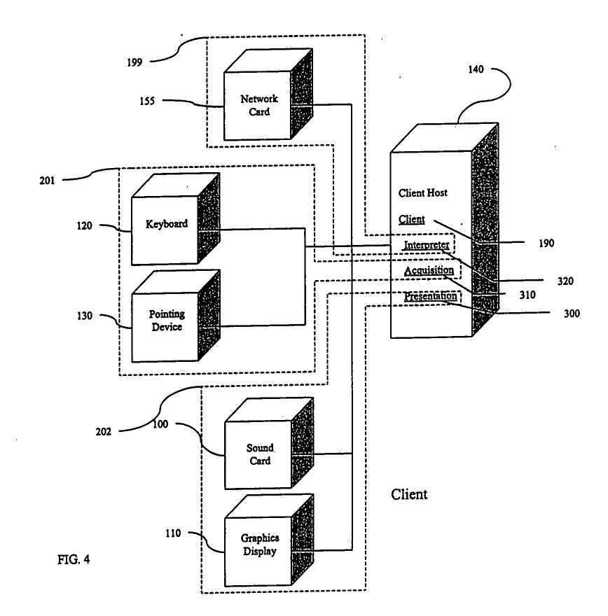

FIG. 4 is a deployment diagram illustrating how the software objects of FIG. 3 may be deployed on client host 140. Client 190 is composed of three main software functional components. Interpreter object 320 communicates over a computer network and parses any documents received from a server. Interpreter 190 uses the services of previously described network card 155 to communicate with servers across a computer network. Acquisition object 310 acquires user input for use by interpreter object 320. Acquisition object 310 uses the services of acquisition devices keyboard 120 and pointing device 130 to acquire user inputs. Alternatively, sound card 110 may also accept audio input and digitize it for use by acquisition object 320. Presentation object 300 accepts presentation data from interpreter object 320 and presents the presentation data to a user. Presentation data may be in the form of digitized audio, graphics, or text. Presentation object 300 uses the services of presentation devices sound card 100 to present audio data and graphics display 110 to present graphical and textual data.

FIG. 4 illustrates that a general purpose computer capable of hosting a client in a client/server system can be organized into at least three separate functional components with each component supplying distinct services. Each functional component can be in turn composed of both software objects and hardware devices. Interpreter object 320 combined with network card 155 supplies computer network communication and document parsing services 199. Acquisition object 310 combined with keyboard 120 and pointing device 130 provide acquisition services 201. Presentation object 300 combined with sound card 100 and graphics display 110 provide presentation services 202.

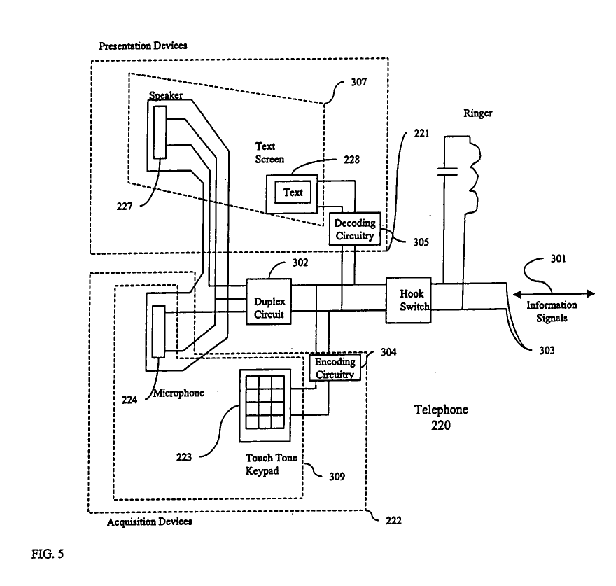

FIG. 5 is a schematic an exemplary conventional telephone handset, keypad, and small text screen suitable for providing presentation and acquisition services as described above. The operation of the exemplary telephone is fully explained in “Cable Communications” (E. R. Bartlett, McGraw-Hill, 1995), incorporated herein by reference. A telephone handset receives and transmits information signals 301 over a single pair of telephone wires 303 through duplex circuit 302. The purpose of the duplex circuit it to provide coupling between speaker 227 and telephone lines 303 and microphone 224 to telephone lines 303 without allowing direct coupling between speaker 227 and microphone 224. Touch tone keypad 223 is attached to telephone lines 303 through encoding Dual Tone Multiple Frequency (DTMF) encoder 304. Encoder 304 translates keypad entries into audio signals suitable for transmission over telephone line 303. Text screen 228 is coupled through decoding circuit 305. Decoding circuit 305 detects the portion of information signals 301 that are suitable for decoding into textual data and sends the textual data to text screen 228. Exemplary textual data are “caller identifier” data accompanying voice data sent over telephone line 303.

Conventional telephone 220 is an example of an information device capable of acquiring information from and presenting information to a user. An information device does so by providing acquisition and presentation services to the user. Acquisition services provided by telephone 220 can be comprised of both acquisition devices and supporting circuitry. Microphone 224 and keypad 223 are exemplary acquisition devices 309. Encoding circuit 304 and the portion of duplex circuit 302 devoted to routing information to microphone 224 are exemplary circuitry supporting exemplary acquisition devices 309. Microphone 224, duplex circuit 302, and encoding circuit 304 comprise the acquisition services 222 available on telephone 220. Speaker 227 and text screen 228 are exemplary presentation devices 307. Decoding circuit 305 and the portion of duplex circuit 302 devoted to routing information to speaker 227 are exemplary circuitry supporting exemplary presentation devices 307. Speaker 227, text screen 228, duplex circuit 302, and decoding circuit 305 comprise the presentation services 221 available on telephone 220.

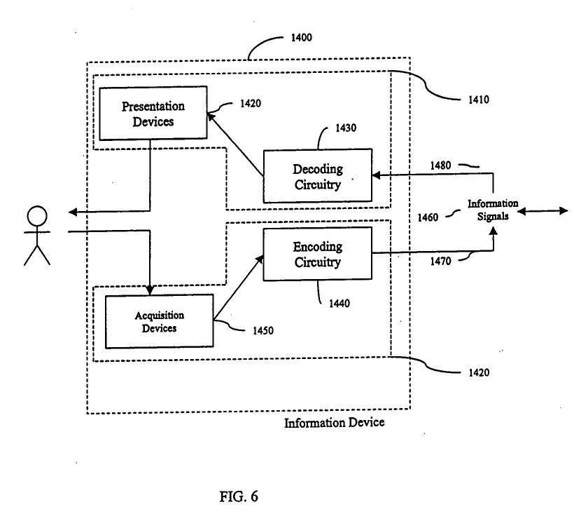

FIG. 6 is an illustration of the features of a generic information device. The services provided by information device 1400 to user 1490 are grouped into two main categories. Presentation services 1410 take incoming data 1480 from information signals 1460, and transform incoming data 1480 into a format suitable for perception by user 1490 by operation of presentation device 1420. Incoming data 1480 may pass through optional decoding circuitry 1430 before incoming data 1480 reaches presentation device 1420. Acquisition services 1420 accept input from user 1490 through acquisition devices 1450 and transform user input into outgoing data 1470. Outgoing data may pass through optional encoding circuitry 1440 before becoming part of information signals 1460.

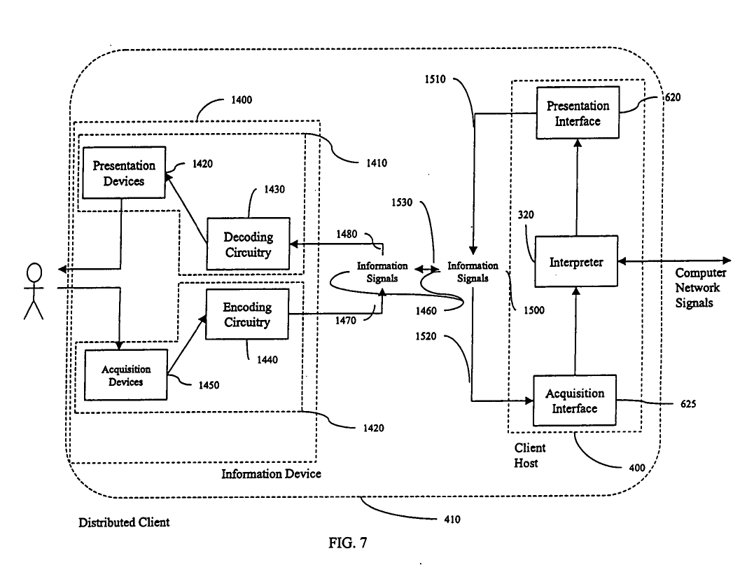

FIG. 7 illustrates how an information device such as the one described in FIG. 6 may be coupled with a client host as described in FIG. 4 to create a distributed client. Previously described client host 400 and previously described information device 1400 can be linked through communications link 1530. Information device 1400 supplies user presentation and acquisition services to the software objects deployed on client host 400. The software objects deployed on client host 400 supply computational services for computer network communications and for document interpretation. Together, information device 1400 and client host 400 supply hardware devices suitable for deployment of software objects comprising a distributed client 410. An exemplary client/server interaction was previously described in FIG. 3. The exemplary interaction illustrated that a client may be thought of as having three main components and each component may be composed of both software and hardware elements. Distributed client 410 of FIG. 7 contains three main components as well; however, the presentation and acquisition components of FIG. 3 are further comprised of presentation interface software object 620 and acquisition interface software object 625 hosted by client host 400. Presentation interface object 620 and acquisition interface object 625 provide communication and formatting services to interpreter object 320. The precise services of presentation interface 620 and acquisition interface 625 are dependent on the type of information device used to create distributed client 410. An exemplary presentation interface for a telephone information device may supply Text-To-Speech (TTS) conversion capabilities for converting textual documents into audio signals suitable for transmission to a telephone. The exemplary presentation interface for a telephone information device may also supply services for conversion of a digitally recorded message stored as a file into audio signals suitable for transmission to a telephone. An exemplary acquisition interface for a telephone information device may provide Automatic Speech Recognition (ASR) services. An ASR allows a user's speech to be recognized for a small number of words or phrases. An exemplary acquisition interface for a telephone information device may also provide DTMF decoding services for transforming DTMF audio signals into digital tokens useful to interpreter 320.

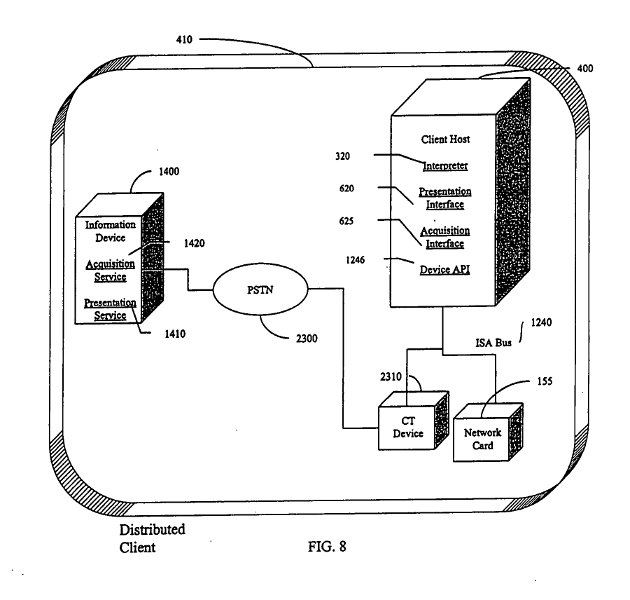

FIG. 8 is a deployment diagram showing how the software objects of FIG. 7 may be deployed on a client host. Previously described client host 400 can be further augmented with Computer Telephony (CT) device 2310. An exemplary CT device is model no. D/41ESC supplied by the Dialogic corporation. This device is a four port voice processing board that allows host based speech processing for TTS and ASR functions. The device also allows DTMF decoding, speech encoding, and speech playback. CT device 2310 is connected to client host 400 via Industry Standard Bus (ISA) 1240. The client host can also be connected to previously described network card 155. CT device is connected via Public Switched Telephone Network (PSTN) 2300 to previously described information device 1400 comprising acquisition services 1420 and presentation services 1410. Client host 400 hosts previously described interpreter 320, presentation interface 620, and acquisition interface 625. Device Application Programming Interface (API) 1246 provides software interface services for CT device 2310.

Those skilled in the art of software engineering will recognize that a distributed client can be consolidated into a local client on an information device which has sufficient computational and presentation and acquisition services to fully support a full client implementation. An exemplary information device with sufficient computational and presentation and acquisition services is a Personal Digital Assistant (PDA). Additional information devices can be used to create a distributed client other than a telephone as previously described. Any information device with some form of presentation and acquisition services accessible over a communications medium may be used. Exemplary communication devices are Telecommunications Device for the Deaf/Teletype (TDD/TTY) devices, personal computers, and wireless devices such as cell phones. The ready adaptability of the distributed client to various information devices creates a pervasive computer networking environment where computer networks may be accessed from any information device.

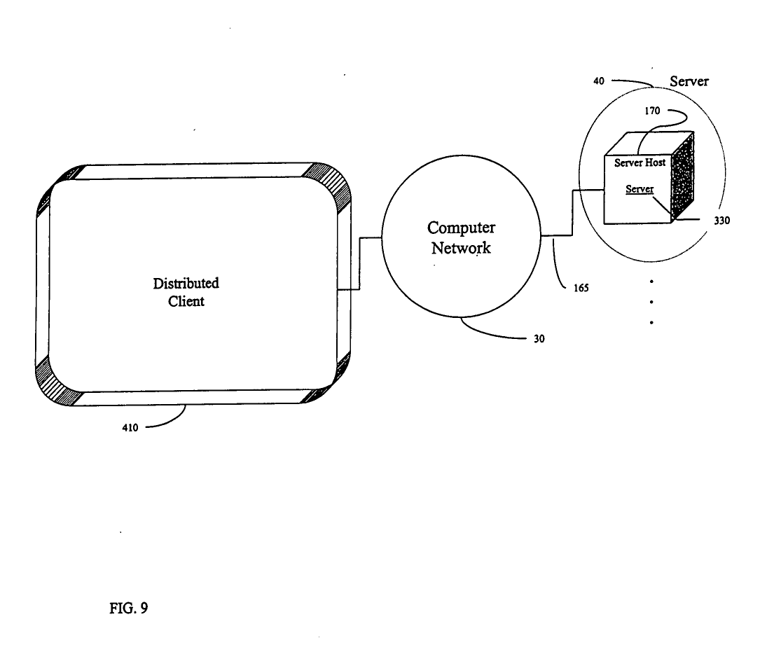

FIG. 9 is a deployment diagram of how the previously described distributed client is integrated into a conventional client/server architecture. Distributed client 410 can connect to computer network 30 and access server host 170. Server host 170 hosts server 330. Server 330 accepts requests from distributed client 410 for documents and responds by serving the requested documents to distributed client 410.

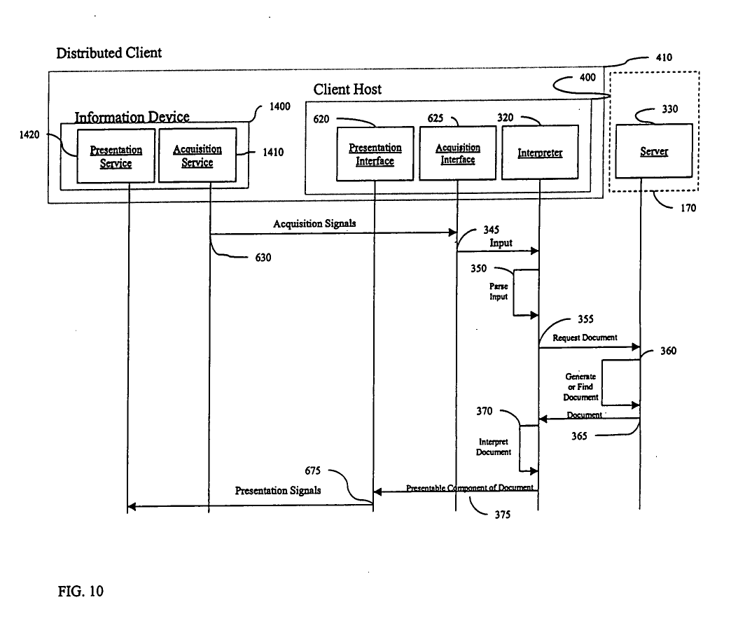

FIG. 10 is a sequence diagram of an exemplary communication sequences for a distributed client and server interaction. Previously described client host 400 hosts previously described presentation interface 620, acquisition interface 625, and interpreter 320. Previously described information device 1400 comprising previously described presentation services 1420 and acquisition services 1410 is linked to client host 400 by a previously described communications link. The combination of information device 1400 and client host 400 creates previously described distributed client 410. Server host 170 hosts server 330. Server host 170 and client host 400 communicate via a previously described computer network. The communication sequence begins a user sending acquisition signals 630 from acquisition services 1410 to software acquisition interface 625. Acquisition signals 630 may comprise speech from the user in which case acquisition interface 625 uses ASR AP0Is to convert user speech into input 345 for use by interpreter 320. The conversion process is typically termed “tokenizing” because each recognizable speech pattern is converted into a unique binary representation, or token, that may be 1 to 4 bytes in length. For example, if speech is detected in acquisition signals 630, ASR software converts spoken numerals and the words “Yes” and “No” into individual tokens that are sent as input 345 to interpreter 320. Alternatively, acquisition signals 630 may comprise DTMF signals in which case acquisition interface 625 tokenizes acquisition signals 630 into input 345 where the tokens correspond to keypad inputs. Interpreter 320 parses 350 input 345 looking for tokens corresponding to a document request. If a document request is found, document request 355 is sent to server 330 and server 330 finds 360 document 365 corresponding to document request 355 and sends document 365 to interpreter 320. Alternatively, document request 355 may correspond to a Common Gateway Interface (CGI) script or its equivalent that may be executed to produce document 365 dynamically. Interpreter 320 receives document 365 and interprets 370 document 365. Document 365 may contain a multitude of components with each component specifying an operation that the interpreter must perform. An exemplary component is a presentation component that is to be sent to information device 1400 for presentation to the user. The presentation component may require transformation into a format suitable for transmission and presentation by the presentation services 1420 found in information device 1400. For example, if document 365 contains a textual presentation component and information device 1400 has an audio based presentation service, then interpreter 320 sends presentable component 375 to presentation interface 620 for transformation of presentable component 375 from text to speech. Presentation interface 620 sends presentation signals 675 to presentation service 1420 located on information device 1400. Presentation signals 675 are converted by presentation service 1420 into audio signals perceivable by the user.

Analysis of FIG. 10 reveals that all of the computational complexity of interpretation of documents by the distributed browser is located on client host 400. Furthermore, significant client side computations can be performed on client host 400 such as executing programs specified by the content of document 365. These client side computations can extend the capabilities of interpreter 320 by adding specific behaviors and features. Information device 1400 is relieved of all computational processing necessary to request and interpret documents. This means any information device can be used in conjunction with client host 400 and appropriate presentation and acquisition interfaces to access and present documents on a computer network.

The format of information contained in documents suitable for interpretation by a distributed client may be different than the formats of documents interpreted by a conventional client as illustrated in FIG. 2. An information device may not have full graphics capability and sophisticated pointing devices. In this case, a concise linked document language may be used to effectively describe documents for interpretation by a distributed client. An analysis of the communication sequence of FIG. 10 reveals certain features of a concise linked document language. A concise linked document language contains facilities for specifying how a document is presented by a distributed browser to the user. A concise linked document language contains facilities for allowing acquisition of user input. Additionally, a concise linked document language has facilities for specifying document links to additional documents on the computer network.

An exemplary concise linked document language is shown in ATTACHMENT A. The exemplary concise linked document language is a language known as Media Independent Presentation Language (CLDL). CLDL is similar to Hyper Text Markup Language (HTML) in that CLDL is a markup language for linked documents. CLDL specifies anchors and links in the same way as HTML. This allows CLDL capable clients to exploit the networked client/server architecture already in place for the exchange of HTML documents using Hyper Text Transfer Protocol (HTTP). This also means any HTTP capable server can be used as a CLDL server. CLDL also shares a similar syntactical structure with HTML through the use of tags, attributes within tags, and free text. However, CLDL and HTML differ in that document links within CLDL are constrained to only appear in navigational tags and are not embedded as hypertext links within the body of the document. These navigational tags within a CLDL document are used to create structured menus that guide a user through a CLDL server site.

CLDL is distinguishable from HTML in several ways. First, CLDL is intended to be a document language for the transfer of text and audio files. This is because text files may be easily transformed into audio files by text-to- speech programs for presentation on a wide variety of information devices with diverse presentation capabilities. Furthermore, most data on computer networks is already in text format. For example, stock quotes and spot prices for commodities are easily attainable in text formats. The text and audio feature of CLDL allows documents written in CLDL to be presented on any information device which has minimal text or audio presentation capabilities. Second, CLDL has a session exit tag that signals an interpreter to terminate a browsing session with an information device. This allows automated control of the communication session from within the context of a CLDL document. Furthermore, the host client may terminate the session when the information device may not have user acquisition capabilities sufficient to signal a termination request. Third, CLDL contains tags that allow the creation of menu driven document links. The menu driven document links are used to control navigation through a network of CLDL documents. Fourth, CLDL has a tag used to signal the start of data acquisition from the information device wherein the acquired data is transferred to a file. This allows recordings to be made from the information device without going through any unnecessary data transformations on the client side. Fifth, CLDL is concise so that CLDL interpreters can be written which are extremely small and capable of being ported to many existing information devices and client hosts. These and other features and tags are described in ATTACHMENT A which is hereby incorporated by reference into this detailed description.

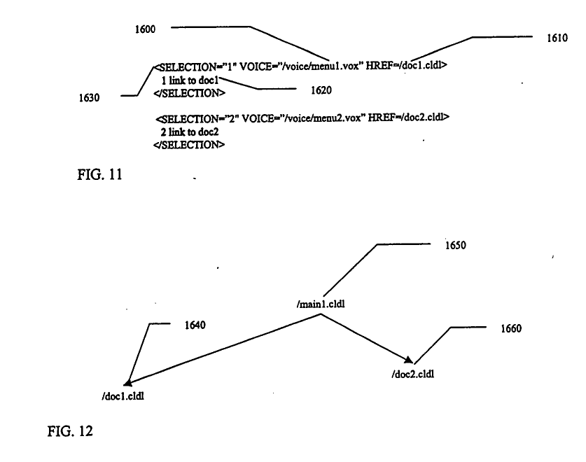

FIG. 11 is a code fragment from a CLDL document. A CLDL SELECTION tag 1630 is specified by enclosing angle brackets “<>”. The numeral “1” specifies that an interpreter is to request the document specified by HREF attribute 1610, “doc1.cld1”, when a user inputs a numeral “1”. Attribute 1600 is a VOICE attribute specifying a file called “menu1.vox” is to be played when the tag is encountered in a CLDL document by an interpreter. Free text 1620 is a textual prompt to be output to the user when the tag is encountered in a CLDL document by an interpreter. These textual and audio prompts comprise the presentation components of the CLDL code fragment. FIG. 12 is a tree diagram of the menu structure created when interpretation of the code fragment of FIG. 10. The main document holding the code fragment is document 1650 named “main1.cld1”. The resultant menu offers selection of item one linked to document 1640 “doc1.cld1”, or item two, linked to document 1660 “doc2.cld1”. If a distributed client is composed of a client host and an information device such as a telephone, then the menu items are output to the user as speech. The user hears the words “One, link to doc one” and “Two, link to doc 2”. If the user says “1”, or enters through the keypad a “1”, the distributed client requests “doc1.cld1” and a new menu system is created. If the user says “238 , or enters through the keypad a “2”, the distributed client requests “doc2.cld1”. In this way, document links are explicitly traversed in a tree structured mode with no backwards traversal as allowed with HTML browsers.

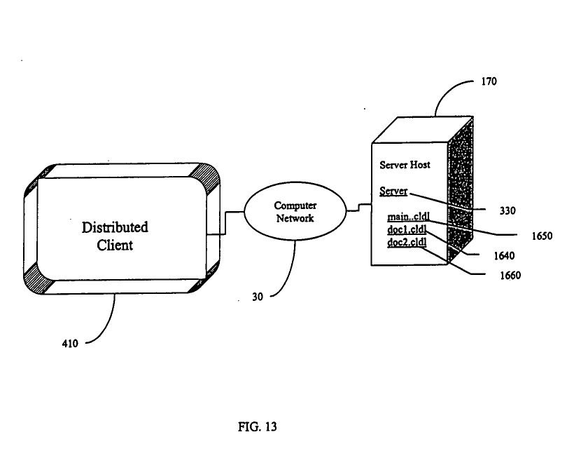

FIG. 13 is a deployment diagram of a distributed client used as an Interactive Voice Recognition (IVR) system. Distributed client 410 is connected through computer network 30 to server host 170. Server host 170 hosts server 330 that serves the CLDL documents 1650, 1640, 1660. Server 330 sends CLDL document 1650, “main.cld1”, to distributed client 410 when distributed client 410 first contacts server 330. CLDL document 1650 contains links to CLDL document 1640, “doc1.cld1”, and CLDL document 1660, “doc2.cld1” within a menu structure as shown in FIGS. 10 and 11. In this way, an IVR system can be implemented using SELECTION tags in CLDL documents to create voice responsive menus linking documents throughout a server site. An exemplary IVR application for a shipping company is illustrated in Attachment A, as a script example.

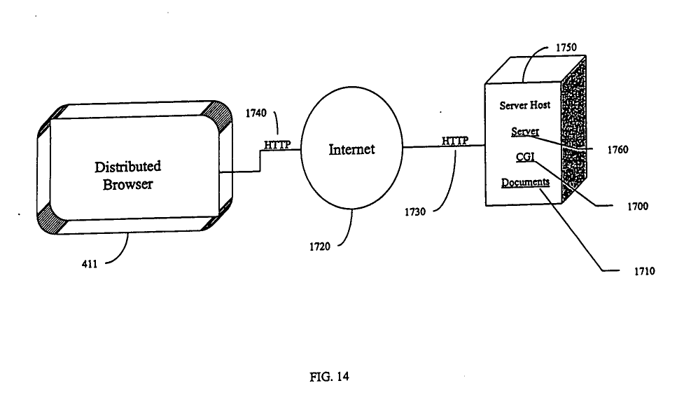

FIG. 14 is a deployment diagram illustrating the use of a distributed client as a distributed browser for communication with Web servers using HTTP. Distributed browser 411 connects via HTTP communications link 1740 to Internet 1720. Server host 1750 connects via HTTP communications link 1730 to Internet 1720. Server host 1750 hosts Web server 1760 that has access to CGI scripts 1700 and CLDL documents 1710. In operation, Web server 1760 waits for document requests sent over Internet 1720 by distributed browser 411. Web server 1760 responds to requests from distributed browser 1720 by serving CLDL documents 1710 to distributed browser 411. Alternatively, CLDL documents are created by CGI scripts 1760 and served to distributed browser 411.

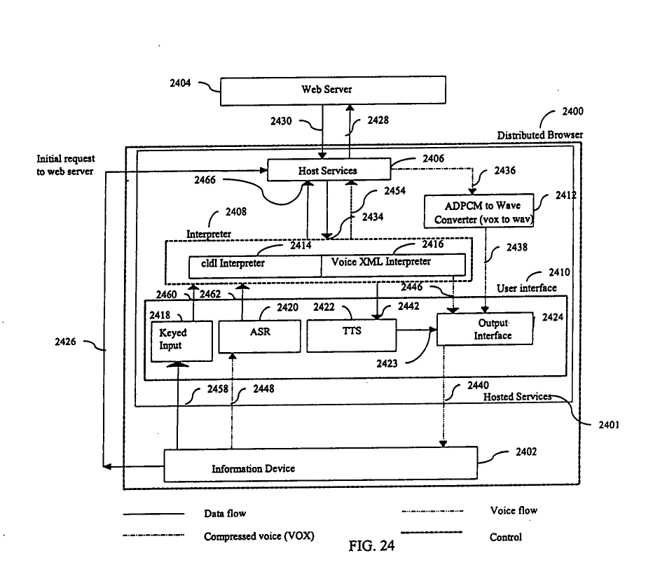

FIG. 24 is a software architecture diagram depicting an embodiment of the present invention suitable for use with a plurality of linked document languages. A user uses a information device 2402 operably coupled to a browser services module 2401 to navigate a Web site composed of documents composed in CLDL or Voice extensible Markup Language (VXML) served by a web server 2404. The browser services module encapsulates the functionality of the software objects hosted by the previously described client host. The combination of the browser services module and the information device comprise a distributed browser 2400 as previously described.

The information device provides presentation functionality allowing the browser services module to send audio output signals 2440 to the user. The information device further provides acquisition functionality allowing keypad input signals 2458, and voice input signals 2448 to be transmitted to the browser services module by the user. An exemplary information device is a cellular telephone. Alternatively, a personal computer equipped with audio input and output features and a keyboard may be used as an information device.

The user uses the information device to send an initial request 2426 to the browser services module. The initial request includes the address of a Web site the user wants to visit. The browser services module sends document request signals 2428 to the Web server and the Web server sends document signals 2430 to the browser services module in response. The document signals encode an electronic document written in a document markup language such as CLDL. The browser services module interprets the electronic document and sends audio and textual components of the electronic document to the information device as audio output signals 2440.

The browser services module comprises a host services interface 2406, an Adaptive Differential Pulse Code Modulation (ADPCM) to Microsoft WAV format converter 2412, and a user interface 2410.

The host services interface is used by the browser services module to open and maintain a communications channel with the Web server for the transmission of request signals 2428 and the reception of an electronic document encoded in document signals 2430.

The electronic document received from the Web server may contain an audio file encoded in an ADPCM format. The browser services module converts the ADPCM formatted audio file into a Microsoft WAV formatted audio file using the ADPCM to WAV converter before sending the audio file 2438 to the user interface. The user interface decodes the WAV formatted file into audio output signals 2440 suitable for transmission to the information device.

A portion of the received document may be written in a document markup language such as CLDL or VXML. The browser services module sends the markup language portion 2434 of the received document to the interpreter 2408 for interpretation. The interpreter parses the markup language portion of the electronic document interpreting any tags or textual components found within the electronic document. Some textual components may contain information to be transmitted to the user. In this case, the interpreter sends the textual components to the user interface for translation into audio output signals 2440 for transmission to the information device. Alternatively, the markup language portion of the received document may contain control tags that specify retrieval of other electronic documents from the Web server. The interpreter converts these control tags into control signals 2454. The browser services module uses the host services interface to convert the control signals to request signals 2428 that are sent to the Web server.

The user responds to the audio output signals by using the information device to produce keyed input signals 2458 or voice input signals 2448 that are transmitted to the user interface. The user interface translates the keyed input signals or voice input signals into tokens 2460 and 2462 that are transmitted to the interpreter. For example, if the electronic document received by the browser services module contains a menu comprised of a choice “1” and a choice “2”, then the user is expected to respond by sending a keyed input of “1” to the browser services module to select the “1” menu choice. The user may do so be either saying the word “one” or pressing the “1” key on a keypad or keyboard. The user interface accepts either the spoken word “one” or the keypad or keyboard keyed input of “1” and translates either input into a token used by the interpreter to determine the user's choice. The interpreter can then react to the user's choice by sending the appropriate control signal 2434 to the host services interface where it is encoded as request signal 2428 before being sent to the Web server.

The interpreter is comprised of a plurality of markup language interpreters operatively coupled together as exemplified by CLDL interpreter 2414 and VXML interpreter 2416. Each markup language interpreter interprets portions of an electronic document written in a specific markup language. For example, the CLDL interpreter interprets portions of an electronic document written in CLDL. If the CLDL interpreter encounters a VXML tag within a portion of an electronic document, the CLDL interpreter invokes the VXML interpreter and the VXML interpreter interprets the VXML tags found in electronic document portion. In a like manner, the VXML interpreter invokes the CLDL interpreter when the VXML interpreter encounters a CLDL tag within a portion of an electronic document. Thus the interpreter can interpret a plurality of markup languages because the interpreter is comprised of a plurality of operably coupled markup language interpreters. In this way, the interpreter can be extended to interpret any markup language by adding additional specific markup language interpreters.

The user interface 2410 is comprised of a keyed input interface 2418, an Automatic Speech Recognition (ASR) interface 2420, a Text To Speech (TTS) interface, and an output interface 2424.

The keyed input interface translates keyed input signals 2458 received from the information device into tokens used by the interpreter. For example the CLDL language provides for numeric inputs from a keypad such as found on a telephone. If the information device is a telephone, the keyed input signals 2458 may then be in the form of DTMF signals. The keyed input interface translates the DTMF signals into tokens 2460 for use by the interpreter. Alternatively, the keyed input interface accepts keyboard inputs in the case where the information device is a personal computer.

The ASR interface provides speech to token translation services for the interpreter. The ASR accepts voice input signals 2448 from the information device and translates the voice input signals into tokens 2462 for use by interpreter as previously described.

The TTS interface provides text to speech translation services for the interpreter. The interpreter sends text portions 2442 of electronic documents to the TTS interface for translation into an audio file format such as WAV. The resultant audio file 2423 is sent to output interface 2424 for translation into audio output signals 2440 that are transmitted to the information device.

The output interface accepts audio files and translates the audio files into audio output signals to be transmitted to the information device. For example, the previously described ADPCM to WAV converter accepts audio signals encoded in an ADPCM format and translates the ADPCM formatted signals into a WAV file. The WAV file is then sent to the output interface for translation into audio output signals to be sent to the information device. The output interface is operably coupled to the previously described TTS interface as well. Additionally, the output interface accepts input directly from the VXML interpreter 2416.

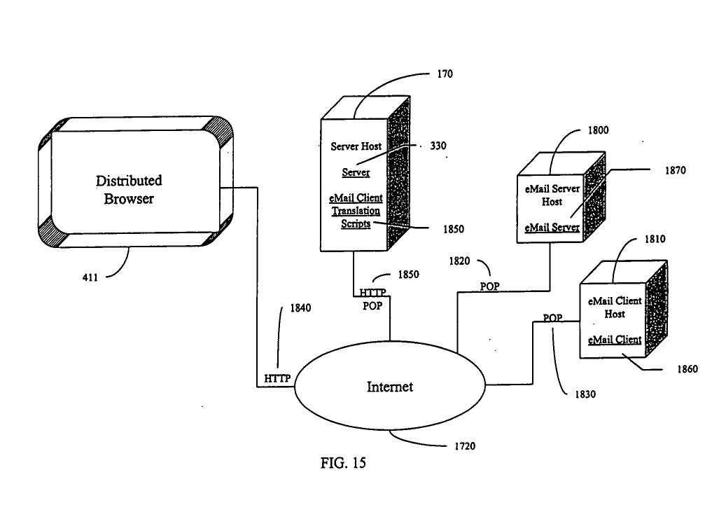

FIG. 15 is a deployment diagram of an exemplary voice/electronic mail (email) system which exploits the features of a concise linked document language coupled with a distributed client. Email client host 1810 connects via Post Office Protocol (POP) communications link 1830 to Internet 1720. Email server host 1800 connects via POP communications link 1820 to Internet 1720. Server host 170 connects via HTTP/POP communications link 1850 to Internet 1720. Distributed browser 411 connects to Internet 1720 via HTTP communications link 1840. Email client 1860 hosted by email client host 1810 can be used to post email messages to email server 1870 hosted by email server host 1800. Distributed browser 411 uses email client translation scripts hosted by server host 170 to retrieve and translate email messages into a concise linked document language such as CLDL.

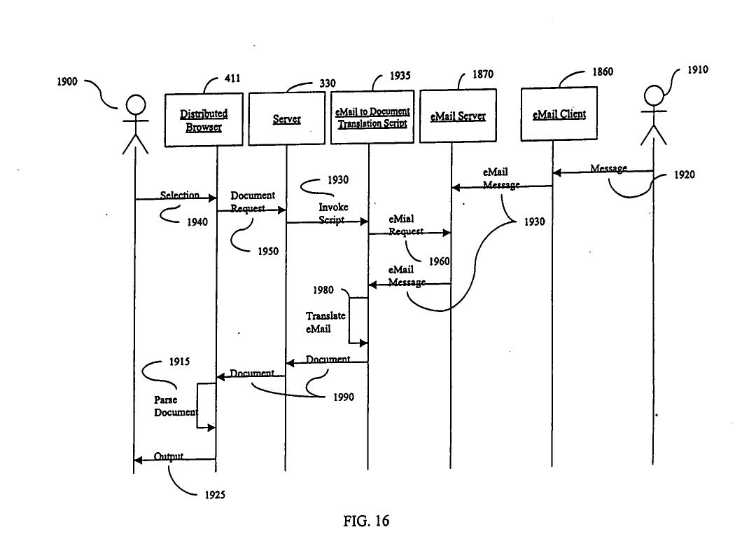

FIG. 16 illustrates the communication sequence of the software objects of FIG. 15. A sender 1910 uses email client 1860 to send message 1920 as email message 1930 to email server 1870. A receiver 1900 makes selection 1940 from a menu presented by distributed browser 411. Distributed browser 411 creates document request 1950 from selection 1940 and sends document request 1950 using HTTP to server 330. Server 330 invokes 1930 email to document translation script 1935. Email to document translation script 1935 sends email request 1960 to email server 1870 using POP. Email server 1870 sends email message 1930 to email to document translation script 1935. Email to document translation script translates 1980 email message 1930 into a document 1990 written in a concise linked document language. Document 1990 is sent to server 330 and server 330 forwards document 1990 using HTTP to distributed browser 411. Distributed browser 411 parses 1915 document 1990 and sends any document specified output 1925 to receiver 1900.

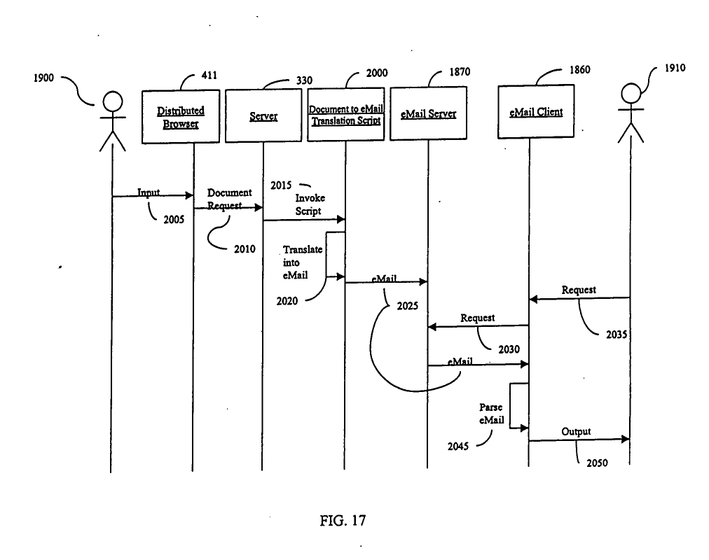

FIG. 17 is a sequence diagram illustrating the sending of a voice mail message as an email message. Sender 2060 sends speech input 2005 to distributed browser 411. Distributed browser 411 formats input 2005 into a HTTP POST document request 2010. Input 2005 is digitized and appended to the header of document request 2010 as a binary file. Server 330 invokes document to email translation script 2000 and sends the encoded speech binary file to document to email translation script 2000. Document to email translation script 2000 formats the encoded speech binary file into an attachment attached to email message 2025. Email message 2025 is sent to email server 1870 using POP. Receiver 2075 makes a request 2035 for email client 1860 to request 2030 email message 2025 from email server 1870. Email server 1870 sends email message 2025 to email client 1860. Email client 1860 parses 2045 email message 2025 and sends the encoded speech binary file as output 2050 to receiver 2070.

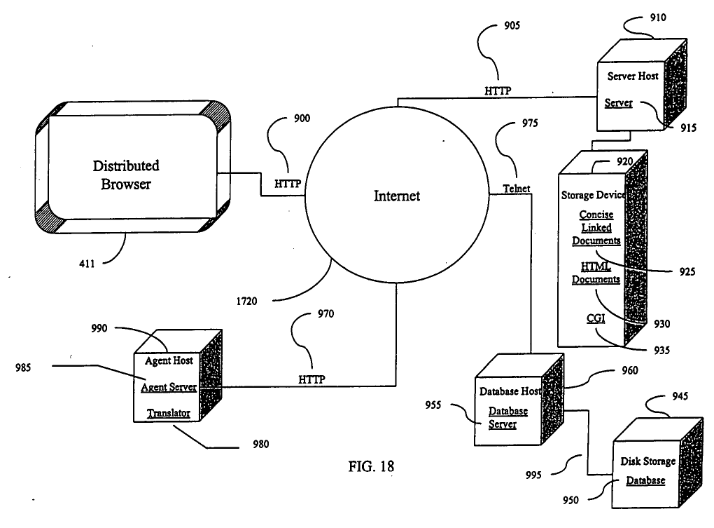

FIG. 18 is an exemplary use of a distributed browser to create an Internet based IVR system that accesses all of the available data resources on the Internet. Distributed browser 411 connects via HTTP communications link 900 to Internet 1720. Internet 1720 serves as a computer communications network connecting distributed browser 411 to a plurality of Internet document servers as exemplified by server host 910. Server host 910 can be connected to storage device 920. Distributed browser 411 can request server 915 hosted by server host 910 to serve any of concise linked documents 925 and HTML documents 930 stored on storage device 920. Alternatively, concise linked documents and HTML documents can be dynamically created using CGI scripts 935. Database host 960 communicates via communications link 975 to Internet 1720. Database server 955 hosted by database host 960 may communicate with server 915 over Internet 1720 using a variety of communications protocols supported by Internet 1720. Exemplary communications protocols are Telnet, HTTP, and FTP. Database server 955 accesses database 950 stored on disk storage device 945. Database server 955 acts as an Internet interface to database 950 by accepting requests from Internet clients and reformatting the requests into a database query language such as Standard Query Language (SQL), querying the database, and sending the query results back to the Internet client. Agent host 990 is connected to Internet 1720 via HTTP communications link 970. Agent host 990 hosts agent server 985 that uses translator 980 to translate HTML documents into documents written in a concise linked document language.

The Internet based IVR operates in the following manner. A user accesses distributed client 411. Distributed client 411 may request documents from any of the plurality of Web servers or servers hosted by the plurality of server hosts on the Internet as exemplified by server host 910. If a requested document is written in a concise linked document language, such as concise linked documents 925, then distributed browser 411 requests and receives the document and presents the contents of the document to the user as speech or text as previously illustrated in the communications sequence of FIG. 10. Alternatively, documents can be dynamically generated in concise linked document language by CGI scripts 935 accessible from server 910. Complete IVR applications can be implemented by supplying users with access to a distributed browser such as distributed browser 411 and writing documents for the IVR applications entirely in a concise linked document language and storing the documents on a server host such as server host 910. Additional functionality can be added by creating CGI scripts which dynamically create documents written in a concise linked document language and storing the CGI scripts on a server host such as server host 910.

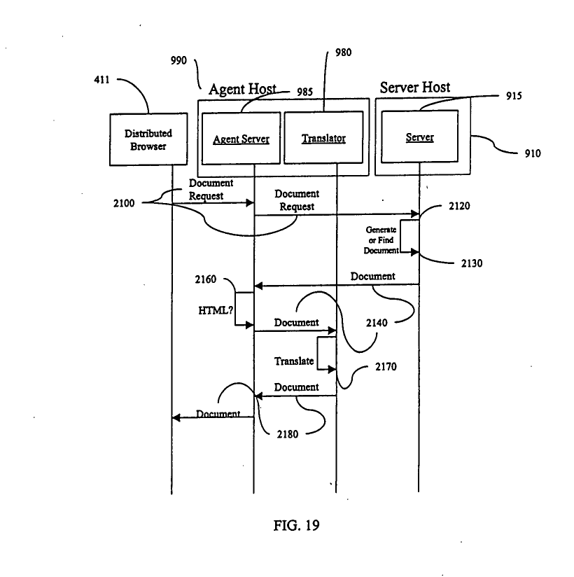

The Internet IVR illustrated in FIG. 18 may access other Internet resources, such as Web pages written in HTML, as illustrated in FIG. 19. Distributed browser 411 makes document request 2100 through agent server 985 that acts like a proxy server. Agent server forwards document request 2100 to server 915 hosted by server host 910. Server 915 finds or generates document 2140 and sends document 2140 to agent server 985. Agent server 985 parses document 2140 and determines 2160 if document 2150 contains HTML tags. If HTML tags are found in the document, agent server 985 invokes translator 980 and sends document 2140 to translator 980. Translator 980 translates 2170 document 2140 into document 2180 written in a concise linked document language. Document 2180 is returned to agent server 985 and agent server 985 sends document 2180 to distributed browser 411. Distributed browser interprets document 2180 and then waits for additional user input.

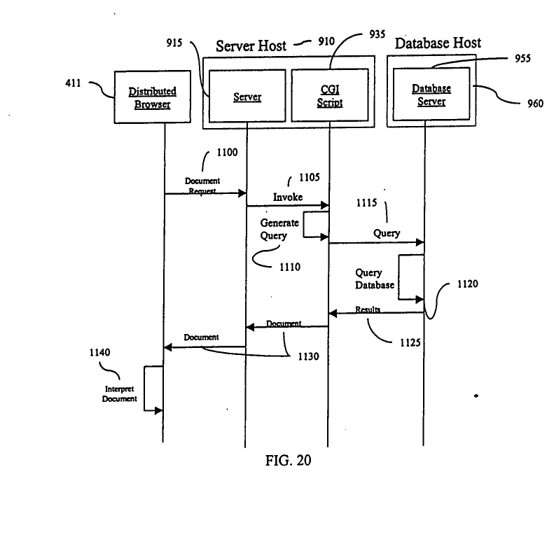

FIG. 20 illustrates how Internet accessible data sources external to the previously described Internet IVR system may be accessed using the previously described Internet IVR system. Distributed browser 411 sends document request 1100 to server 915 hosted by server host 910. Document request 1100 can be formatted as a “GET” operation wherein query data is sent as a data field appended to the document request. Web server 915 invokes CGI script 935 hosted by server host 910. CGI script 935 generates 1110 query 1115 from information found in document request 1100. Query 1115 is sent to database server 955 hosted by database server host 960. Database server 955 queries 1120 its associated database and sends results 1125 to CGI script 935. CGI script 935 formats results 1125 into document 1130 written in a concise linked document language and sends document 1130 to server 915 which forwards document 1130 to distributed browser 411. Distributed browser 411 interprets 1140 document 1130 as previously illustrated in FIG. 10. Alternatively, document request 1100 can be formatted as a “PUT” wherein data intended for inclusion in the database supported by database server 955 is appended to a form document header and sent to database server 955. In this way, data may be transferred to and from a data resource which is connected to the Internet but does not have a concise linked document language based interface.

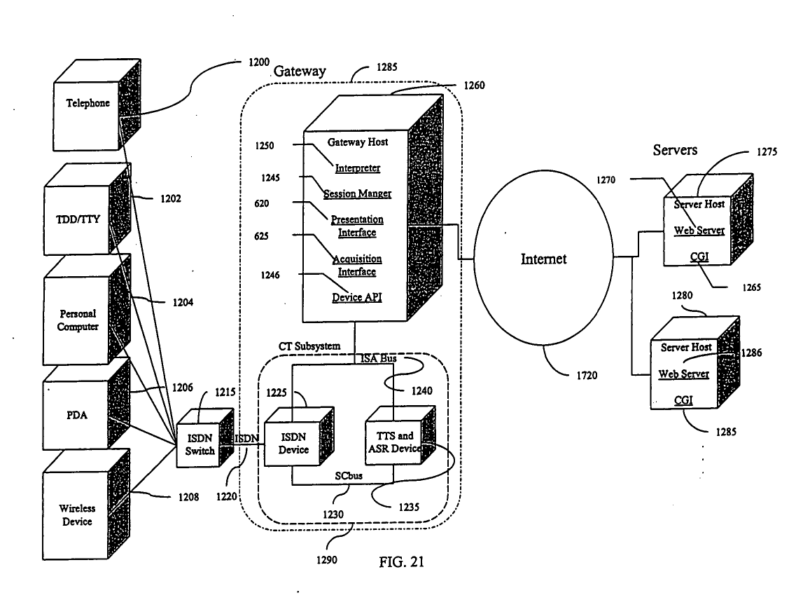

FIG. 21 is a deployment diagram of an Internet communications gateway according to the present invention. Such an Internet gateway can be used to provide a plurality of information devices access to a plurality of servers on the Internet. Exemplary information devices telephone 1200, TTD/TTY device 1202, Telecommunications Device for the Deaf/Teletype (TDD/TTY) device 1204, personal computer 1204, Personal Data Assistant (PDA) 1206, and wireless device 1208 connect through Integrated Services Digital Network (ISDN) switch 1215 and ISDN carrier 1220 to ISDN device 1225. The ISDN switch and the ISDN device communicate with each other using ISDN protocols over a T-1 trunk line. ISDN protocols based on a T-1 data trunk allow 23 logical communications channels, called B channels, and 1 data channel, called a D channel. The B channels carry communications data and the D channel carries call sequence and identification data associated with each B channel.

Gateway 1285 is comprised of two main subsystems. A CT subsystem 1290 and a gateway host. The CT subsystem comprises ISDN device 1225 and Text-To-Speech (TTS) and Automatic Speech Recognition (ASR) device 1235. ISDN device 1225 allows software control of B channels and querying of D channel data found in IDSN carrier 1220. TTS and ASR device 1235 provides text to speech functions, DTMF decoding functions, and speech recognition services. ISDN Device 1225 and TTS and ASR device 1235 communicate with each other over Signal Computing bus (SCbus) 1230. An exemplary ISDN device is offered by the Dialogic Corporation as model D/480SC-2T1. An exemplary TTS and ASR device is offered by the Dialogic Corporation as model number Antares 2000/50. The Antares 2000/50 is a Digital Signal Processor (DSP) platform that requires third party firmware and Application Program Interface (API) software to operate. An exemplary firmware and software package is offered by Lernout & Hauspie as model number L&H ASR1500/T for ASR functions and L&H TTS3000/T for TTS functions. Gateway host 1260 can be a single board computer with a Pentium class processor capable of running a multitasking operating system such as UNIX. ISDN device 1225 and TTS and ASR device 1235 connect via ISA bus 1240 to gateway host 1260. Exemplary ISDN device 1225 and TTS and ASR device 1235 are controlled by software objects hosted by gateway host 1260 through device Application Programming Interface (API) functions 1246.

Software object interpreter 1250 is hosted by gateway host 1260 and performs Internet communication and concise linked document language interpretation functions as previously described. In practice, a plurality of interpreters are instantiated as separate sessions. The number of instantiated interpreters is based on the number of incoming calls through ISDN switch 1215. Each incoming call from ISDN switch 1215 can have its own interpreter session. The multiple interpreter sessions are managed by session manager 1245 hosted by gateway host 1260. Session manager 1245 queries ISDN interface 1225 for D channel data and decodes an information element found in the D channel data for processing of Direct Inward Dial (DID) numbers associated with logical B channels in ISDN carrier 1220. Gateway 1285 is a communications gateway to a plurality of Web servers as exemplified by server hosts 1275 and 1280. Server host 1275 hosts Web server 1270 which processes requests and delivers documents written in a concise linked document language stored on server host 1275. Alternatively, server 1275 may invoke CGI scripts 1265 to dynamically create documents written in a concise linked document language. Web server 1270 can communicate with Interpreter sessions instantiated on gateway host 1260 through Internet 30 using HTTP communication protocols.

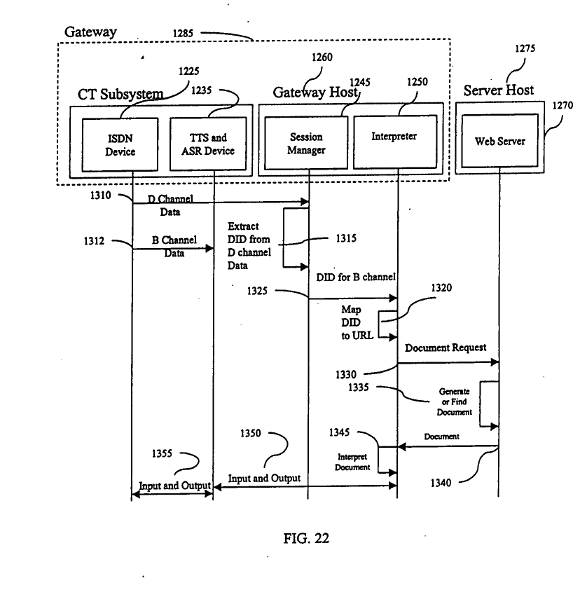

FIG. 22 illustrates how the software objects deployed in FIG. 21 cooperate to create an Internet gateway accessible from an information device. ISDN device 1225 accepts input from previously described ISDN switch 1215 of FIG. 13. ISDN device 1225 detects incoming calls on the logical B channels of the ISDN carrier and performs all necessary call setup functions. ISDN device 1225 decodes the D channel data contained in the ISDN carrier and makes the D channel data available to session manager 1245. Session manager 1245 uses Application Program Interface (API) software functions to query and control ISDN device 1225. ISDN device 1225 is queried by session manager 1235 to determine the DID for each B channel that has an active call session. Session manager 1245 receives D channel data 1310 from ISDN device 1225 and extracts 1315 DID number for 1325 for B channel data 1312 sent by ISDN device 1225 to TTS and ASR device 1235. Session manager 1245 invokes an interpreter 1250 in a separate process on gateway host 1260 and passes DID 1310 for B channel data 1312 to interpreter 1250. Interpreter 1250 maps DID channel 1310 to a URL previously assigned to the DID. Interpreter 1250 uses the URL to create document request 1330 for Web server 1270 located at the URL. Server 1270 finds 1335 document 1340 corresponding to document request 1330 and sends document 1340 to interpreter 1250. Alternatively, server 940 uses CGI scripts or their equivalents to dynamically generate document 1340. Interpreter 1250 interprets 1355 document 1340 and utilizes TTS and ASR device API to receive and transmit input and output 1350 between the interpreter and ISDN device 1225. A separate interpreter is invoked on gateway host 1260 for each B channel available from ISDN device 1225. Each invoked interpreter uses the DID of the invoked interpreter's corresponding B channel to open a connection to a Web server on the Internet. In this way, a plurality of information devices may communicate with a plurality of Web servers located on the Internet through a single gateway host thus creating an Internet gateway.

There are several alternative embodiments of the gateway system. In one embodiment, the type of information device connected via the ISDN trunk line is detected by the gateway using a plurality of methods and handshaking protocols. For example, to determine if the information device is a telephone or a text only device, the gateway can send a voice signal to the information device request a speech or keypad input from the user. If no speech or keypad input is received, the gateway can conclude a text only information device is connected to the gateway. Alternatively, certain DID numbers can be reserved for particular devices. For example, if a call is received on DID number 1010, then the gateway invokes an interpreter and acquisition and presentation interfaces suitable for telephonic communications. If a call is received on DID number 1020, then the gateway invokes an interpreter and acquisition and presentation interfaces suitable for textual devices.

In another embodiment of a gateway system according to the present invention, the DID to URL mapping is accomplished by storing DID and URL associations in a database accessible via a database server operably coupled to the gateway system's session manager.

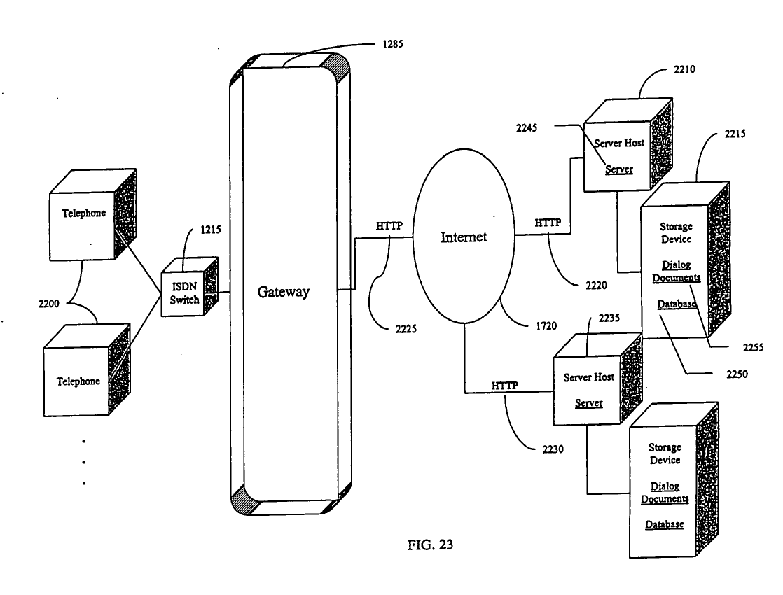

FIG. 23 illustrates how the Internet gateway of FIG. 21 may be advantageously employed to create a distributed IVR system supporting a plurality of users and content providers. Users use a plurality of telephones, 2200, to connect via ISDN switch 1215 to gateway 1285. Gateway 1285 connects to Internet 1720 via communications link HTTP 2225. A plurality of server hosts, as exemplified by server hosts 2210 and 2235, connect to Internet 1720 via exemplary HTTP communications links 2230 and 2220. Each server hosts a server as exemplified by server 2245. Each server has access to a storage device as exemplified by storage device 2215. Each storage device contains dialog documents as exemplified by dialog documents 2255. Each storage device may also contain a database as exemplified by database 2250.

In operation, gateway 1285 is a virtual point of presence for content providers providing content on exemplary servers 2210 and 2235. The telephone numbers used to access the gateway may be keyed to any geographic location thus appearing to a user that the content provider is located in that geographic location. In reality, the content provider need only supply a single hosted site on the Internet and that hosted site may be accessible from a multitude of gateways located in any geographic location. Additionally, the distributed architecture of the IVR applications allows the business and dialog logic of an IVR application to be separated from the IVR call switching and management logic. The separation is achieved by isolating the dialog logic using dialog documents hosted entirely by the content provider and not by the gateway provider. The dialog documents can implement any desired business logic as well through the use of CGI scripts and their equivalents.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by claims supported by this application and the claim's equivalents rather than the foregoing description.

1. A voice/e-mail system for use with an information device, comprising:
a computing device operably coupled via a communications link to the information device, the computing device operably coupled to a computer network, the computing device including: a processor; and
a memory operably coupled to the processor and having program instructions stored therein, the processor being operable to execute the program instructions, the program instructions including:
receiving voice message signals from the information device via the communications link;
receiving an e-mail address from the information device via the communications link;
generating an electronic document including the voice message signals;
transmitting the electronic document to the e-mail address via the computer network.

2. The voice/e-mail system of claim 1, wherein the electronic document is written in a concise linked document language.

3. The voice/e-mail system of claim 1, the program instructions further including:
retrieving an electronic document from an e-mail server via the computer network, the electronic document including a voice message; and
transmitting the voice message via the communications link to the information device.

4. The voice/e-mail system of claim 1, the program instructions further including:
retrieving an e-mail message from an e-mail server via the computer network, the e-mail message including a text portion;
translating the text portion of the e-mail message into a voice message; and
transmitting the voice message via the communications link to the information device.

5. A method of transmitting voice messages from an information device via e-mail, comprising:
providing a computing device operably coupled via a communications link to the information device, the computing device operably coupled to a computer network
receiving by the computing device from the information device via the communications link voice message signals;
receiving by the computing device from the information device via the communications link an e-mail address;
generating by the computing device an electronic document including the voice message signals;
transmitting by the computing device to the e-mail address via the computer network the electronic document.

6. The method of claim 5, wherein the electronic document is written in a concise linked document language.

7. The method of claim 5, further comprising: retrieving by the computing device from an e-mail server via the computer network an electronic document, the electronic document including a voice message; and
transmitting by the computing device to the information device via the communications link the voice message.

8. A computer readable media embodying computer program instructions for execution by a computer, the computer program instructions adapting a computer to transmit voice/e-mail message with an information device, the computer program instructions comprising:
receiving voice message signals from the information device via the communications link;
receiving an e-mail address from the information device via the communications link;
generating an electronic document including the voice message signals;
transmitting the electronic document to the e-mail address via the computer network.

9. The computer readable media of claim 8, wherein the electronic document is written in a concise linked document language.

10. The computer readable media of claim 8, the program instructions further including:
retrieving an electronic document from an e-mail server via the computer network, the electronic document including a voice message; and
transmitting the voice message via the communications link to the information device.

11. The computer readable media of claim 8, the program instructions further including:
retrieving an e-mail message from an e-mail server via the computer network, the e-mail message including a text portion;
translating the text portion of the e-mail message into a voice message; and
transmitting the voice message via the communications link to the information device.
